(19) United States
(12) Patent Application Publication
(10) Pub. No.: US 2015/0112997 A1
(43) Pub. Date: Apr. 23, 2015

(54) METHOD FOR CONTENT CONTROL AND ELECTRONIC DEVICE THEREOF

(71) Applicant: Samsung Electronics Co., Ltd., Suwon-si (KR)

(72) Inventors: Moon-Soo KIM, Seoul (KR); Ki-Huk LEE, Yongin-si (KR); Jung-Eun LEE, Suwon-si (KR); Ho-Chul HWANG, Seoul (KR)

(21) Appl. No.: 14/492,544

(22) Filed: Sep. 22, 2014

(30) Foreign Application Priority Data
Oct. 21, 2013 (KR) 10-2013-0125346

(51) Int. Cl. G06F 17/30

(52) U.S. Cl. CPC G06F 17/3028
USPC 707/741

(57) ABSTRACT

A method for controlling a content in an electronic device is provided. The method includes detecting first tag information based on a content accessible by the electronic device, detecting second tag information based on an image included in the content, comparing the first tag information with the second tag information, and displaying information indicating that the content is not original on the content, when the first tag information and the second tag information do not satisfy a reference condition.

### CROSS-REFERENCE TO RELATED APPLICATION(S)

This application claims the benefit under 35 U.S.C. §119(a) of a Korean patent application filed on Oct. 21, 2013 in the Korean Intellectual Property Office and assigned Serial No. 10-2013-0125346, the entire disclosure of which is hereby incorporated by reference.

### TECHNICAL FIELD

The present disclosure relates to a technology for determining whether content is forged in an electronic device.

### BACKGROUND

With the development of information and communications technology and semiconductor technology, various electronic devices for providing multimedia services have been developed. For example, mobile electronic devices may provide various multimedia services such as a broadcasting service, a wireless Internet service, a camera service and a music playback service.

Content provided through an electronic device may be modified by a third party regardless of the intention of an original content provider, and then may be shared. The third party may maliciously modify the content to be shared.

Therefore, a method for determining whether content is forged is required.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure provide a device and method for determining whether content is forged by comparing first tag information based on content and second tag information based on an image included in the content.

Another aspect of the present disclosure is to provide a device and method for indicating whether content is forged.

Another aspect of the present disclosure is to provide a device and method for determining the first tag information on the basis of at least one of information on a content creation time, information on the weather at the content creation time, and information on a location at the content creation time.

Another aspect of the present disclosure is to provide a device and method for determining the second tag information on the basis of at least one of information on a time at which the image is inserted into the content, information on weather at the time at which the image is inserted into the content and information on a location at the time at which the image is inserted into the content.

Another aspect of the present disclosure is to provide a device and method for displaying information indicating that the content is not original on the image.

Another aspect of the present disclosure is to provide a device and method for releasing display of the image if the content is not original.

Another aspect of the present disclosure is to provide a device and method for notifying that the content is not original by generating an acoustic signal (e.g., sound) or a tactile signal (e.g., vibration).

Another aspect of the present disclosure is to provide a device and method for adding the second tag information to the image to insert the image into the content and for adding the first tag information to the content to store the content.

Another aspect of the present disclosure is to provide a device and method for displaying the image on the content.

Another aspect of the present disclosure is to provide a device and method for synthesizing the image and the content to store the image and the content as a single file.

Another aspect of the present disclosure is to provide a device and method for storing the image and the content as different files.

In accordance with an aspect of the present disclosure, a method for controlling content in an electronic device is provided. The method includes determining first tag information based on a content accessible by the electronic device, determining second tag information based on an image included in the content, comparing the first tag information with the second tag information, and displaying information indicating that the content is not original on the content, when the first tag information and the second tag information do not satisfy a reference condition.

In accordance with an aspect of the present disclosure, a method for controlling content in an electronic device is provided. The method includes adding second tag information to an image to insert the image into content, and adding first tag information to the content to store the content.

In accordance with an aspect of the present disclosure, an electronic device is provided. The electronic device includes a memory, a display, and a processor configured to determine first tag information based on content stored in the memory, determine second tag information based on an image included in the content, compare the first tag information with the second tag information, and control the display so that information indicating that the content is not original is displayed on the content when the first tag information and the second tag information do not satisfy a reference condition.

In accordance with an aspect of the present disclosure, an electronic device is provided. The electronic device includes a memory, a display, and at least one processor configured to add second tag information to an image, insert the image into content, add first tag information to the content, and store the content in the memory.

In accordance with an aspect of the present disclosure, a method in an electronic device is provided. The method includes generating metadata associated with content, generating a watermark to be included with the content, detecting contextual information contemporaneous with the generation of the watermark, generating metadata associated with the watermark according to the detected contextual information, and inserting the watermark and associated metadata in the content.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to various embodiments of the present disclosure;

FIG. 2 is a block diagram illustrating a processor according to various embodiments of the present disclosure;

FIG. 3 is a diagram illustrating a procedure of adding tag information to an image to store content in an electronic device according to various embodiments of the present disclosure;

FIG. 4 is a diagram illustrating a procedure of adding time information to an image to store content in an electronic device according to various embodiments of the present disclosure;

FIG. 5 is a diagram illustrating a procedure of adding weather information to an image to store content in an electronic device according to various embodiments of the present disclosure;

FIG. 6 is a diagram illustrating a procedure of adding location information to an image to store content in an electronic device according to various embodiments of the present disclosure;

FIGS. 7A, 7B, 7C and 7D are diagrams illustrating screen configurations for adding tag information to an image to store content in an electronic device according to various embodiments of the present disclosure;

FIG. 8 is a diagram illustrating a procedure of determining whether content is original using tag information of an image included in the content in an electronic device according to various embodiments of the present disclosure;

FIG. 9 is a diagram illustrating a procedure of determining whether content is original using time information of an image included in a content in an electronic device according to various embodiments of the present disclosure;

FIG. 10 is a diagram illustrating a procedure of determining whether content is original using weather information of an image included in a content in an electronic device according to various embodiments of the present disclosure;

FIG. 11 is a diagram illustrating a procedure of determining whether content is original using location information of an image included in a content in an electronic device according to various embodiments of the present disclosure; and

FIGS. 12A, 12B, 12C and 12D are diagrams illustrating screen configurations for indicating whether content is original using tag information included in a content in an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to the present disclosure may be any one or combination of various devices including a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, a mobile medical device, an electronic bracelet, an electronic necklace, an electronic accessory, a camera, a wearable device, an electronic clock, a wrist watch, a smart home appliance (e.g., a refrigerator, an air conditioner, a cleaner, an artificial intelligence robot, a TV, a digital versatile disk (DVD) player, an audio, an oven, a microwave oven, a washing machine, an air cleaner and an electronic picture frame), a medical device (e.g., magnetic resonance angiography (MRA), magnetic resonance imaging (MRI), or computed tomography (CT) scanning machine, and an ultrasonic device), a navigation device, a global positioning system (GPS) receiver, an event data recorder (EDR), a flight data recorder (FDR), a set-top box, a TV box (e.g., Samsung HomeSync™, Apple TV™, and Google TV™), an electronic dictionary, a vehicle infotainment device, a marine electronic device (e.g., a marine navigation device and a gyro compass), an aviation device, a security device, electronic clothes, an electronic key, a camcorder, a game console, a head-mounted device (HMD), a flat display device, an electronic album, a part of furniture or building/structure having a communication functions, an electronic board, an electronic signature input device, a projector, and/or the like. According to various embodiments of the present disclosure, an electronic device may be any combination of the foregoing devices. It would be obvious to those skilled in the art that the electronic device according to the present disclosure is not limited to the above-mentioned devices.

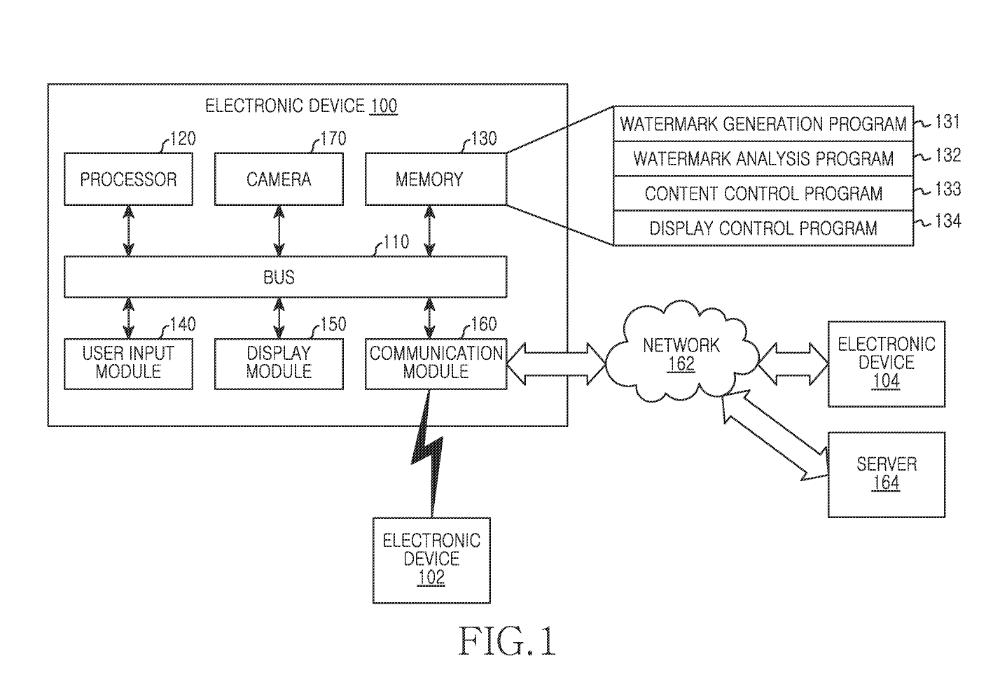

FIG. 1 is a block diagram illustrating an electronic device according to various embodiments of the present disclosure.

Referring to FIG. 1, an electronic device 100 may include a bus 110, a processor 120, a memory 130, a user input module 140, a display module 150, a communication module 160, a camera 170, and/or the like.

The bus 110 may be a circuit for connecting the elements (e.g., the bus 110, the processor 120, the memory 130, the user input module 140, the display module 150, the communication module 160, the camera 170, and/or the like) included in the electronic device 100 to each other and for transferring communication signals (e.g., control messages) among the elements.

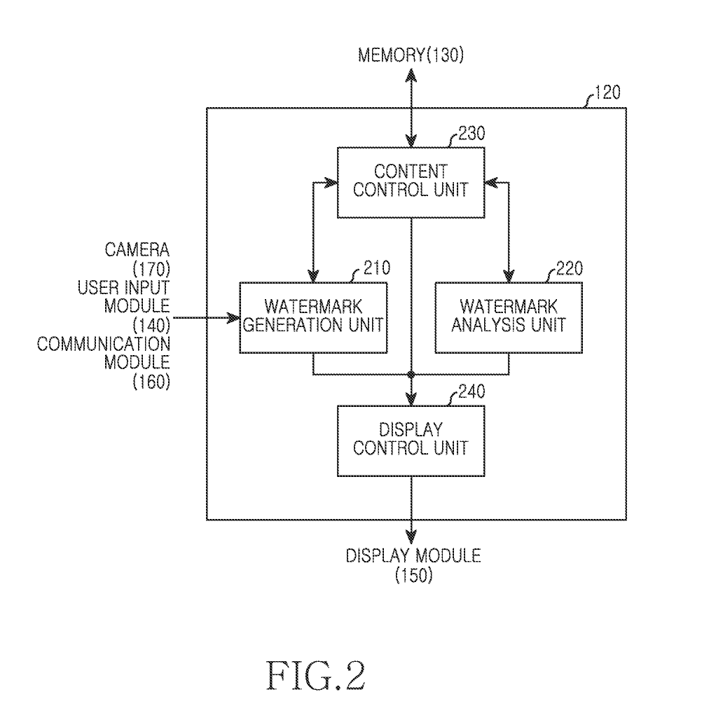

The processor 120 may receive commands from the elements included in the electronic device 100 through the bus 110, may interpret the received commands, and may perform operations or data processing according to the interpreted commands. The processor 120 may execute at least one application stored in the memory 130 so that a service is provided according to the application. For example, the processor 120 may be configured as illustrated in FIG. 2 to control content by executing a watermark generation program 131, a watermark analysis program 132, a content control program 133 and a display control program 134.

The processor 120 may include at least one application processor (AP) or at least one communication processor (CP) (not illustrated). The AP and the CP may be included in the processor 120 or may be respectively included in different IC packages. Alternatively, the AP and the CP may be included in a single IC package. The AP may run an operating system or an application program so as to control a plurality of hardware or software components connected to the AP, and may perform operations and may process various types of data including multimedia data. The AP may be implemented with a SoC. The CP may perform at least a part of a multimedia control function. The CP may identify and authenticate terminals in a communication network using a subscriber identification module (e.g., a SIM card). The CP may provide services such as a voice call service, a video call service, a text message service and a packet data transmission service to a user. Furthermore, the CP may control data transmission/reception of the communication module 160. The AP and/or the CP may load, on a volatile memory, a command or data received from at least one of a nonvolatile memory connected to the AP and/or the CP and another element so as to process the command or data. Furthermore, the AP or the CP may store, in the nonvolatile memory, data received from or generated by at least one of other elements. The CP may manage a data link and convert a communication protocol for communication between the electronic device including hardware and other electronic devices connected thereto through a network. The CP may be implemented with a SoC. In addition, the processor 120 may further include a graphics processor unit (GPU).

The memory 130 may store a command or data received from or generated by the processor 120 and/or another element (e.g., the user input module 140, the display module 150, the communication module 160, the camera 170, and/or the like). The memory 130 may include an internal buffer and an external buffer. For example, the memory 130 may store an image shot by the camera 170. As another example, the memory 130 may store a signature as an image on the basis of a touch input received through the user input module 140.

The memory 130 may include the watermark generation program 131, the watermark analysis program 132, the content control program 133, the display control program 134, and/or the like. Each application may include a programming module. A programming module may include software, firmware, hardware, or a combination of at least two thereof.

The watermark generation program 131 includes at least one software component for controlling insertion of a watermark image into content. For example, in the case of inserting at least one watermark image into content, the watermark generation program 131 may determine first tag information on the basis of at least one of information on a time at which the image is inserted into the content, information on the weather at the time at which the image is inserted into the content, and information on a location at the time at which the image is inserted into the content.

The watermark analysis program 132 includes at least one software component for analyzing tag information of a watermark image included in content so as to determine whether the content is forged. For example, when a content display event occurs, the watermark analysis program 132 may determine second tag information determined on the basis of at least one of information on a content creation time, information on the weather at the content creation time, and information on a location at the content creation time. The watermark analysis program 132 may determine the first tag information on the basis of at least one of the information on the time at which the image is inserted into the content, the information on the weather at the time at which the image is inserted into the content, and the information on a location at the time at which the image is inserted into the content. Thereafter, the watermark analysis program 132 may compare the first tag information with the second tag information so as to request the display control program 134 to display information indicating that the content is not original when content forgery is detected.

The content control program 133 includes at least one software component for adding a watermark image to content. For example, when the watermark generation program 131 requests insertion of the watermark image (e.g., in response to the watermark generation program 131 requesting insertion of the watermark image), the content control program 133 may add the watermark image to the content. The control program 133 may determine whether to display the watermark image. Furthermore, the content control program 133 may synthesize the watermark image and the content so as to store the watermark image and the content as a single file. Furthermore, the content control program 133 may store the watermark image as a file separate from the content.

The display control program 134 includes at least one software component for controlling the display module 150 so that at least one content is displayed. For example, the display control program 134 may control the display module 150 so that at least one content is displayed. As another example, the display control program 134 may control the display module 150 so that at least one watermark image is displayed.

The memory 130 may include an internal memory or an external memory. The internal memory may include at least one of a volatile memory (e.g., a dynamic random-access memory (DRAM), a static random-access memory (SRAM), a synchronous dynamic random access memory (SDRAM)), a nonvolatile memory (e.g., a one-time programmable read-only memory (OTPROM), a programmable read-only memory (PROM), an erasable programmable read-only memory (EPROM), an electrically erasable programmable read-only memory (EEPROM), a mask read-only memory (ROM), a flash ROM, a NAND flash memory, a NOR flash memory, and/or the like). The internal memory may be a solid state device (SSD). The external memory may include at least one of a CF card, an SD card, a micro-SD card, a mini-SD card, an xD card and a memory stick.

The memory 130 may further include a kernel, middleware, and an application programming interface (API). The kernel may control or manage system resources (e.g., the bus 110, the processor 120, and the memory 130) used to perform processes or functions of other programming modules (e.g., the middleware, the API, and applications). Furthermore, the kernel may provide an interface for allowing the middleware, the API, and/or an application to access individual elements of the electronic device 100 in order to control or manage the elements. The middleware may serve as an intermediary so that the API or application communicates with the kernel to exchange data. Furthermore, the middleware 132 may perform load balancing with respect to operation requests received from at least one application by using, for example, a method of assigning a priority for using system resources (e.g., the bus 110, the processor 120, the memory 130, and/or the like) of the electronic device 100 to the operation requests. The API, which is an interface for allowing an application to control a function provided by the kernel or middleware, may include at least one interface or function for file control, window control, image processing, character control, and/or the like.

The user input module 140 may receive a command or data from a user, and may transfer the command or data to the processor 120 or the memory 130 through the bus 110. For example, the user input module 140 may include a touch panel, a pen sensor, a key, an ultrasonic input device, and/or the like. For example, the touch panel may recognize a touch input using at least one of a capacitive detection method, a resistive detection method, an infrared detection method, an ultraviolet detection method, and/or the like. The touch panel may further include a controller. In the case of using the capacitive detection method, not only a direct touch but also a proximity touch can be recognized. The touch panel may further include a tactile layer. In this case, the touch panel may provide tactile reaction to a user. For example, the pen sensor may be implemented using a method that is similar to or same as the method for receiving a touch input of a user, or may be implemented using an additional sheet for recognition. For example, the key may include a keypad or a touch key. The ultrasonic input device generates ultrasonic signals through a pen so that the electronic device detects sound waves through a microphone to identify data, wherein the ultrasonic input device can be wirelessly recognized.

The display module 150 may display an image, a video, data, and/or the like to a user. For example, the display module 150 may include a panel or a hologram. For example, the panel may be a liquid crystal display (LCD), an active-matrix organic light-emitting-diode (AM-OLED). The panel may be flexible, transparent, wearable, and/or the like. The panel and a touch panel may be integrated into a single module. For example, the hologram may display a stereoscopic image in a space using a light interference phenomenon. In addition, the display module 150 may further include a control circuit for controlling the panel or the hologram.

The display module 150 may display content according to control by the display control application 134. For example, the display module 150 may display content. As another example, the display module 150 may display a watermark image.

The communication module 160 may enable communication between the electronic device 100 and other electronic devices 102 and 104. The communication module 160 may support a short-range communication protocol (e.g., Wi-Fi, bluetooth (BT), near field communication (NFC), and/or the like), and/or the like. The communication module 160 may support communication with a network 162 (e.g., Internet, a local area network (LAN), a wide area network (WAN), a telecommunication network, a cellular network, a satellite network, a plain old telephone service (POTS) network, and/or the like). The communication module 160 may enable communication with a server 164 (e.g., using communication across the network 162 and/or the like).

The camera 170 may capture an image of a subject through an image sensor.

An image processing unit (not illustrated), which is an image signal processor (ISP), may convert output data (e.g., raw data) from the camera 170 into image frame data having a predetermined format (RGB/YUV) and may provide the image frame data to the processor 120. The image processing unit may be included in the camera 170. Alternatively, the image processing unit may be included in the processor 120.

Each of the other electronic devices 102 and 104 may be the same (e.g., same type) as the electronic device 100 or may be different (e.g., different type) from the electronic device 100.

In addition, the electronic device 100 may further include a sensor module. The sensor module may include at least one of a gesture sensor, a gyro sensor, a barometric sensor, a magnetic sensor, an acceleration sensor, a grip sensor, a proximity sensor, a red, green, blue (RGB) sensor, a biometric sensor, a temperature/humidity sensor, an illuminance, a UV sensor, and/or the like. Furthermore, the sensor module may measure physical quantity or detect an operation state of the electronic device so as to convert measured or detected information into an electric signal. For example, the sensor module may include an olfactory sensor, an EMG sensor, an EEG sensor, or a fingerprint sensor. Furthermore, the sensor module may further include a control circuit for controlling at least one sensor included therein.

The names of the hardware elements according to the present disclosure may be changed according to the type of the electronic device. The hardware according to the present disclosure may include at least one of the above-mentioned elements, and some elements may be omitted or other additional elements may be added. Furthermore, some of the elements of the hardware according to the present disclosure may be combined with each other so as to form one entity, so that the functions of the elements may be performed in the same manner as before the combination.

FIG. 2 is a block diagram illustrating the processor according to various embodiments of the present disclosure.

Referring to FIG. 2, the processor 120 includes a watermark generation unit 210, a watermark analysis unit 220, a content control unit 230, and a display control unit 240.

The watermark generation unit 210 executes the watermark generation program 131 stored in the memory 130 so as to control insertion of a watermark image. For example, in the case of inserting at least one watermark image into content, the watermark generation unit 210 may determine the first tag information on the basis of at least one of information on a time at which the image is inserted into the content, information on the weather at the time at which the image is inserted into the content, information on a location at the time at which the image is inserted into the content, and/or the like.

The watermark analysis unit 220 executes the watermark generation program 131 stored in the memory 130 and analyzes tag information of the watermark image included in the content so as to determine whether the content is forged. For example, when a content display event occurs (e.g., in response to occurrence of the content display event), the watermark analysis unit 220 may determine the second tag information determined on the basis of at least one of information on a content creation time, information on the weather at the content creation time, and information on a location at the content creation time. The watermark analysis unit 220 may determine the first tag information on the basis of at least one of the information on the time at which the image is inserted into the content, the information on the weather at the time at which the image is inserted into the content, and the information on a location at the time at which the image is inserted into the content. Thereafter, the watermark analysis unit 220 may compare the first tag information with the second tag information so as to request the display control unit 240 to display information indicating that the content is not original when content forgery is detected.

The content control unit 230 executes the content control program 134 stored in the memory 130 so that a watermark image is added to content. For example, when the watermark generation unit 210 requests insertion of the watermark image (e.g., in response to the control unit receiving a request for an insertion of the watermark image), the content control unit 230 may add the watermark image to the content. The content control unit 230 may determine whether to display the watermark image. Furthermore, the content control unit 230 may synthesize the watermark image and the content so as to store the watermark image and the content as a single file. Furthermore, the content control unit 230 may store the watermark image as a file separate from the content.

The display control unit 240 executes the display control program 134 stored in the memory 130 so that content is displayed through the display module 150. For example, the display control unit 240 may control the display module 150 so that at least one content is displayed. As another example, the display control unit 240 may control the display module 150 so that at least one watermark image is displayed.

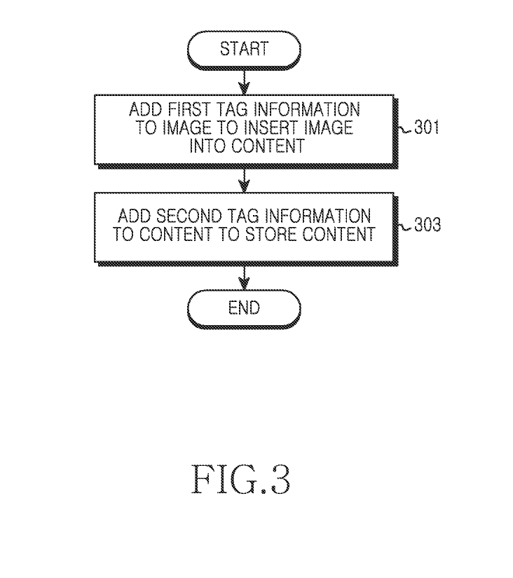

FIG. 3 is a diagram illustrating a procedure of adding tag information to an image to store content in an electronic device according to various embodiments of the present disclosure.

Referring to FIG. 3, at operation 301, the electronic device adds first tag information to an image and inserts the image into content. The image represents a watermark image for determining whether the content is forged (e.g., to determine whether the content is unaltered or is otherwise genuine). For example, in the case according to which at least one watermark image is inserted into the content, the electronic device may determine the first tag information on the basis of at least one of information on a time at which the image is inserted into the content, information on the weather at the time at which the image is inserted into the content, and information on a location at the time at which the image is inserted into the content.

At operation 303, the electronic device adds second tag information to the content and stores the content. For example, when a content storage event occurs (e.g. in response to the content storage event), the electronic device may determine the second tag information on the basis of at least one of information on a content creation time, information on the weather at the content creation time, information on a location at the content creation time, and/or the like.

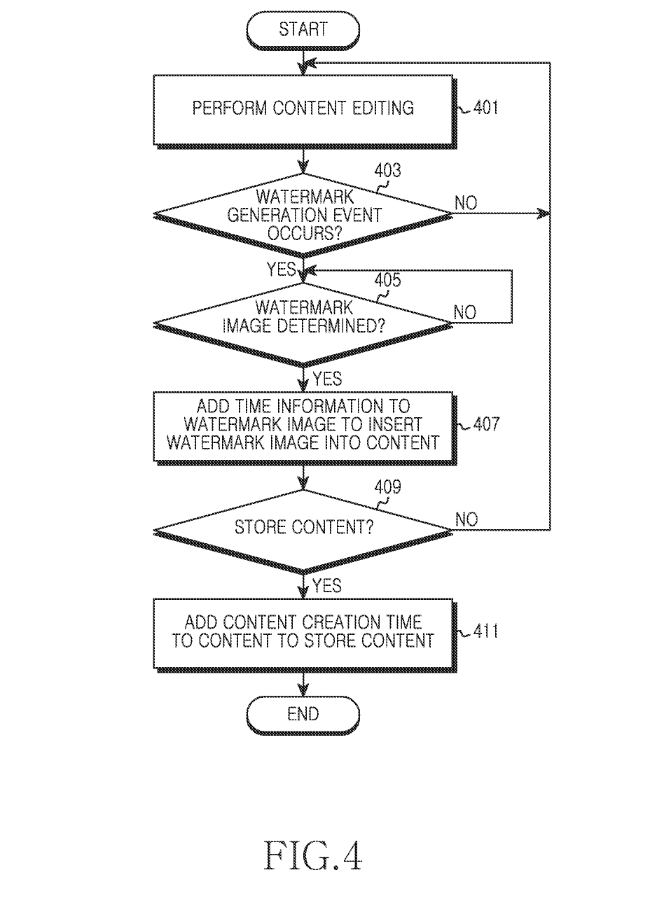

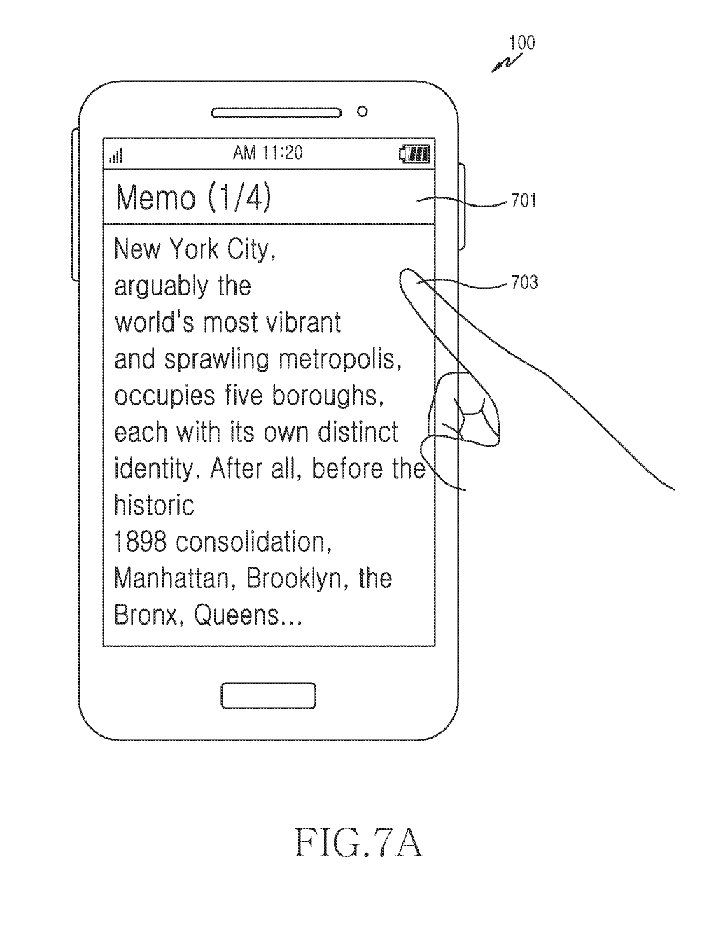

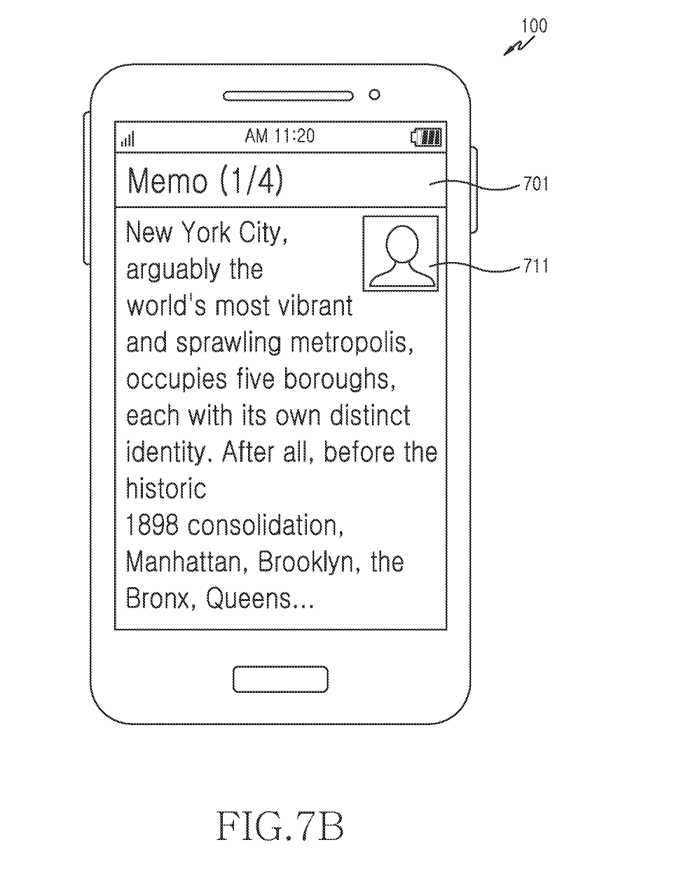

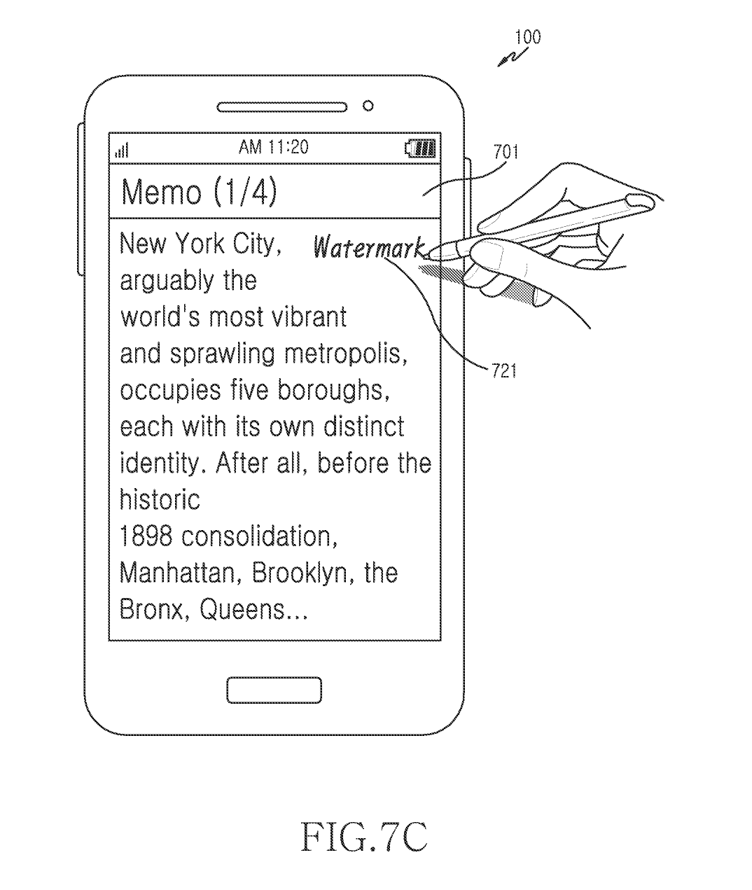

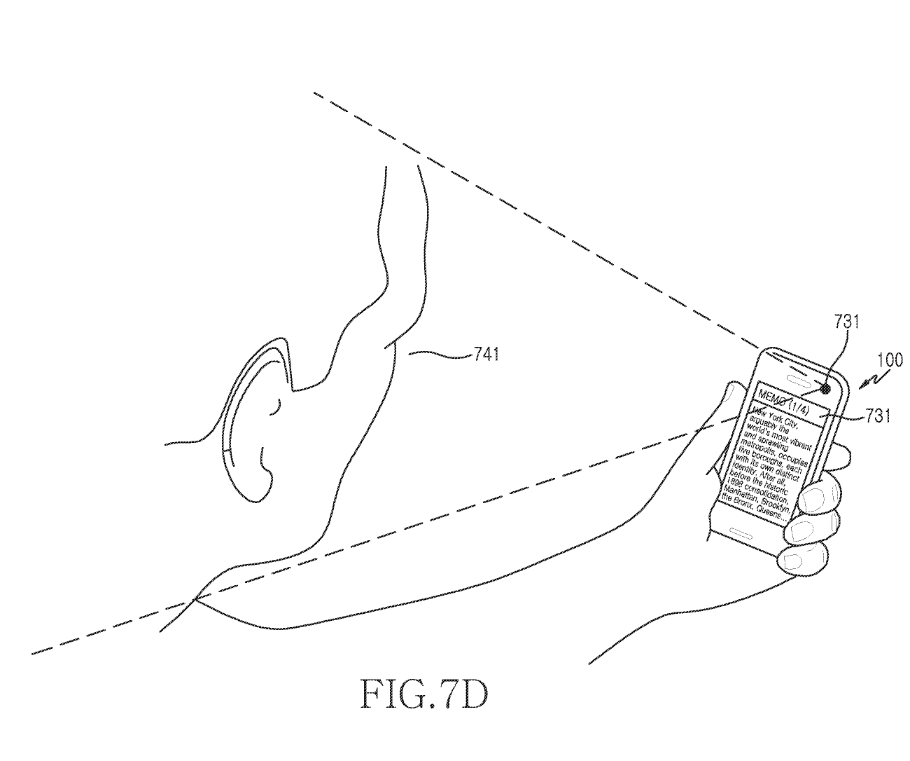

FIG. 4 is a diagram illustrating a procedure of adding time information to an image to store content in an electronic device according to various embodiments of the present disclosure. FIGS. 7A, 7B, 7C and 7D are diagrams illustrating screen configurations for adding tag information to an image to store content in an electronic device according to various embodiments of the present disclosure.

Referring to FIG. 4, at operation 401, the electronic device performs content editing. For example, as illustrated in FIG. 7A, the electronic device may edit (e.g., insert, delete, resize, move, and/or the like) at least one of a text, an image (e.g., a clip art, a picture, an emoticon, and/or the like) and a video through a memo program 701.

At operation 403, the electronic device determines whether a watermark generation event occurs. For example, the electronic device may determine whether a menu for inserting a watermark into the memo program 701 illustrated in FIG. 7A is selected.

If the electronic device determines that the watermark generation event does not occur at operation 403, then the electronic device may proceed to operation 401 at which the electronic device performs content editing.

In contrast, if the electronic device determines that the watermark generation event occurs at operation 403, then the electronic device may proceed to operation 405 at which the electronic device determines whether a watermark image is determined. As an example, in response to the watermark generation event, the electronic device may determine whether a watermark image is determined. For example, the electronic device may determine whether at least one of a plurality of images that can be used as watermark images is determined as a watermark image. The image may include at least one of an image stored in a memory, an image shot by a camera, an image stored in a server, and/or the like. For another example, the electronic device may determine whether a result (e.g., signature or image) of inputting handwriting of a user is determined as the watermark image.

If the electronic device does not determine the watermark image at operation 405, then the electronic device may continue to poll at operation 405 until the watermark image is determined.

In contrast, if the electronic device determines the watermark image at operation 405, then the electronic device may proceed to operation 407 at which the electronic device adds time information to the watermark image and inserts the watermark image into content. For example, as illustrated in FIG. 7B, in the case according to which a first image 711 is determined as the watermark image, from among the plurality of images that can be used as watermark images, the electronic device stores a time at which the first image 711 is inserted into the memo program 701. The electronic device may add (e.g., to Exchangeable Image File Format (EXIF) information, the time at which the first image 711 is inserted. As another example, as illustrated in FIG. 7C, in the case according to which a signature 721 handwritten by the user is determined as the watermark image, the electronic device may store a time at which the signature 721 is inserted into the memo program 701.

At operation 409, the electronic device determines whether to store the content. For example, the electronic device may determine whether to store a memo created through the memo program 701 illustrated in FIG. 7B or 7C in the memory according to menu manipulation by the user.

If the electronic device determines not to store the content at operation 409, then the electronic device may return to operation 401 at which the electronic device performs content editing.

In contrast, if the electronic device determines to store the content at operation 409, then the electronic device may proceed to operation 411 at which the electronic device adds a content creation time to the content and stores the content. For example, in the case according to which the memo created through the memo program 701 illustrated in FIG. 7B or 7C is stored in the memory, a time at which the memo is created may be added to the memo to store the memo. The memo creation time may be a time at which an event for storing the memo occurs or a time at which the memo is finally edited.

According to the various embodiments of the present disclosure described above, the electronic device may add to the content, the time at which the watermark image is inserted into the content so as to store the content.

According to various other embodiments of the present disclosure, the electronic device may add, to the content, information on the weather at the time at which the watermark image is inserted into the content so as to store the content.

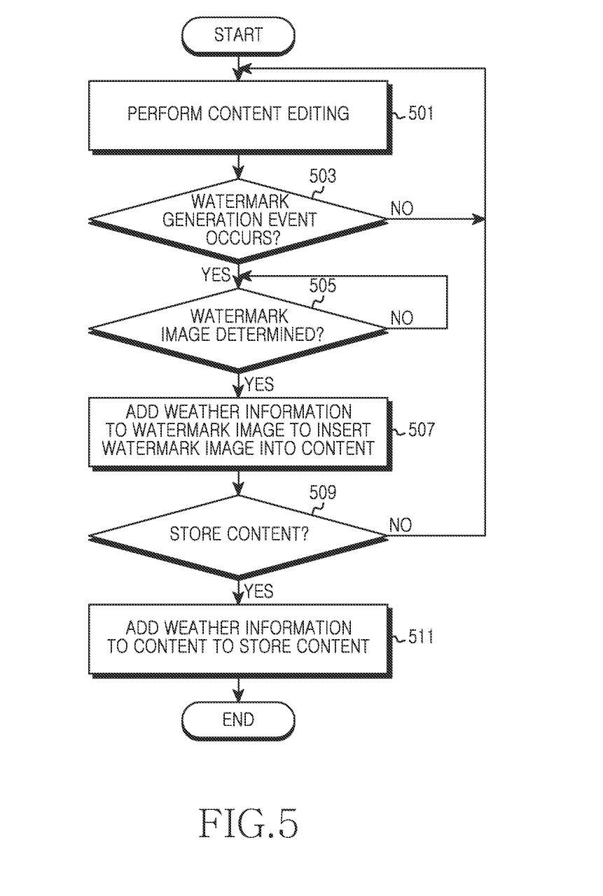

FIG. 5 is a diagram illustrating a procedure of adding weather information to an image to store content in an electronic device according to various embodiments of the present disclosure.

Referring to FIG. 5, at operation 501, the electronic device performs content editing. For example, as illustrated in FIG. 7A, the electronic device may edit (e.g., insert, delete, resize, move, and/or the like) at least one of a text, an image (e.g., a clip art, a picture, an emoticon, and/or the like) and a video through the memo program 701.

At operation 503, the electronic device determines whether a watermark generation event occurs. For example, the electronic device may determine whether a menu for inserting a watermark into the memo program 701 illustrated in FIG. 7A is selected.

If the electronic device determines that the watermark generation event does not occur at operation 503, then the electronic device may proceed to operation 501 at which the electronic device performs content editing.

In contrast, if the electronic device determines that the watermark generation event occurs at operation 503, then the electronic device may proceed to operation 505 at which the electronic device determines whether a watermark image is determined. As an example, in response to the watermark generation event, the electronic device may determine whether a watermark image is determined. For example, the electronic device may determine whether at least one of a plurality of images that can be used as watermark images is determined as the watermark image. The image may include at least one of an image stored in a memory, an image captured by a camera, an image stored in a server, and/or the like. As another example, the electronic device may determine whether a result (e.g., signature or image) of inputting handwriting of the user is determined as the watermark image.

If the electronic device does not determine the watermark image at operation 505, then the electronic device may continue to poll at operation 505 until the watermark image is determined.

In contrast, if the electronic device determines the watermark image at operation 505, then the electronic device may proceed to operation 507 at which the electronic device adds weather information to the watermark image and inserts the watermark image into content. The weather information may include at least one of a temperature, an amount of rainfall, a rainfall probability, a wind direction, a wind speed, a humidity, and/or the like. The weather information may be stored in the memory or may be received in real time from the server, a detector operatively connected to the electronic device, and/or the like. For example, as illustrated in FIG. 7B, in the case according to which the first image 711 is determined as the watermark image, from among the plurality of images that can be used as watermark images, the electronic device stores the weather information of the time at which the first image 711 is inserted into the memo program 701. The electronic device may add (e.g., to the EXIF information), the weather information of the time at which the first image 711 is inserted. As another example, as illustrated in FIG. 7C, in the case according to which the signature 721 handwritten by the user is determined as the watermark image, the electronic device may store the weather information of the time at which the signature 721 is inserted into the memo program 701.

At operation 509, the electronic device determines whether to store the content. For example, the electronic device may determine whether to store the memo created through the memo program 701 illustrated in FIG. 7B or 7C in the memory according to menu manipulation by the user.

If the electronic device determines not to store the content at operation 509, then the electronic device may return to operation 501 at which the electronic device performs content editing.

In contrast, if the electronic device determines to store the content at operation 509, then the electronic device may proceed to operation 511 at which the electronic device adds the weather information to the content and stores the content. For example, in the case according to which the memo created through the memo program 701 illustrated in FIG. 7B or 7C is stored in the memory, the weather information of the time at which the memo is created may be added to the memo to store the memo.

According to the various embodiments of the present disclosure described above, the electronic device may add the weather information of the time at which the watermark image is inserted into the content so as to store the content.

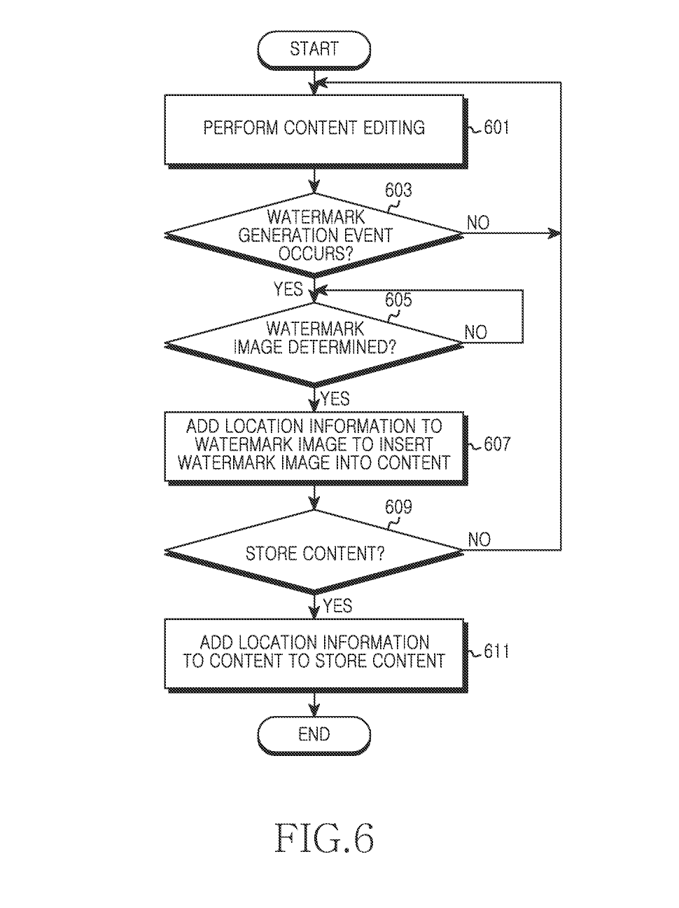

According to various other embodiments of the present disclosure, as illustrated in FIG. 6, the electronic device may add, to the content, location information of the time at which the watermark image is inserted into the content so as to store the content.

FIG. 6 is a diagram illustrating a procedure of adding location information to an image to store content in the electronic device according to an embodiment of the present disclosure.

Referring to FIG. 6, at operation 601, the electronic device performs content editing. For example, as illustrated in FIG. 7A, the electronic device may edit (e.g., insert, delete, resize, move, and/or the like) at least one of a text, an image (e.g., a clip art, a picture, an emoticon, and/or the like) and a video through the memo program 701.

At operation 603, the electronic device determines whether a watermark generation event occurs. For example, the electronic device may determine whether a menu for inserting a watermark into the memo program 701 illustrated in FIG. 7A is selected.

If the electronic device determines that the watermark generation event does not occur at operation 603, then the electronic device may proceed to operation 601 at which the electronic device performs content editing.

In contrast, if the electronic device determines that the watermark generation event occurs at operation 603, then the electronic device may proceed to operation 605 at which the electronic device determines whether a watermark image is determined. As an example, in response to the watermark generation event, the electronic device may determine whether a watermark image is determined. For example, the electronic device may determine whether at least one of a plurality of images that can be used as watermark images is determined as the watermark image. The image may include at least one of an image stored in a memory, an image shot by a camera and an image stored in a server. For another example, the electronic device may determine whether a result (e.g., signature or image) of inputting handwriting of the user is determined as the watermark image.

If the electronic device does not determine the watermark image at operation 605, then the electronic device may continue to poll at operation 605 until the watermark image is determined.

In contrast, if the electronic device determines the watermark image at operation 605, then the electronic device may proceed to operation 607 at which the electronic device adds location information to the watermark image and inserts the watermark image into content. The location information may be determined using at least one of GPS, GNSS, Wi-Fi, cellular communication, and/or the like. For example, as illustrated in FIG. 7B, in the case according to which the first image 711 is determined as the watermark image, from among the plurality of images that can be used as watermark images, the electronic device stores the location information of the time at which the first image 711 is inserted into the memo program 701. The electronic device may add (e.g., to the EXIF information), the location information of the time at which the first image 711 is inserted. As another example, as illustrated in FIG. 7C, in the case according to which the signature 721 handwritten by the user is determined as the watermark image, the electronic device may store the location information of the time at which the signature 721 is inserted into the memo program 701.

At operation 609, the electronic device determines whether to store the content. For example, the electronic device may determine whether to store the memo created through the memo program 701 illustrated in FIG. 7B or 7C in the memory according to menu manipulation by the user.

If the electronic device determines not to store the content at operation 609, then the electronic device may return to operation 601 at which the electronic device performs content editing.

In contrast, if the electronic device determines to store the content at operation 609, then the electronic device may proceed to operation 611 at which the electronic device adds the location information to the content and stores the content. For example, in the case according to which the memo created through the memo program 701 illustrated in FIG. 7B or 7C is stored in the memory, the location information of the time at which the memo is created may be added to the memo to store the memo.

In addition, when a watermark generation event occurs, the electronic device may determine a location 703 to which a watermark is to be inserted as illustrated in FIG. 7A. The electronic device may determine the location to which the watermark is to be inserted on the basis of a user input. Furthermore, the electronic device may determine to insert the watermark into a location preset by a system. According to various embodiments of the present disclosure, the electronic device may determine the location to which the watermark is to be inserted according to a predefined location (e.g., that may be configurable by a user, and/or the like).

According to various embodiments of the present disclosure, as illustrated in FIG. 7D, the electronic device may determine an image of a face 741 of a user captured by a camera 731 as a watermark image and may insert the watermark image into content, without inserting an additional watermark. The electronic device may also determine an image that does not include the face 741 of the user as the watermark image so as to insert the watermark image into the content.

In addition, in the case of inserting the watermark image into the content, the electronic device displays the watermark image inserted into the content. Alternatively, the electronic device may not display the watermark image inserted into the content.

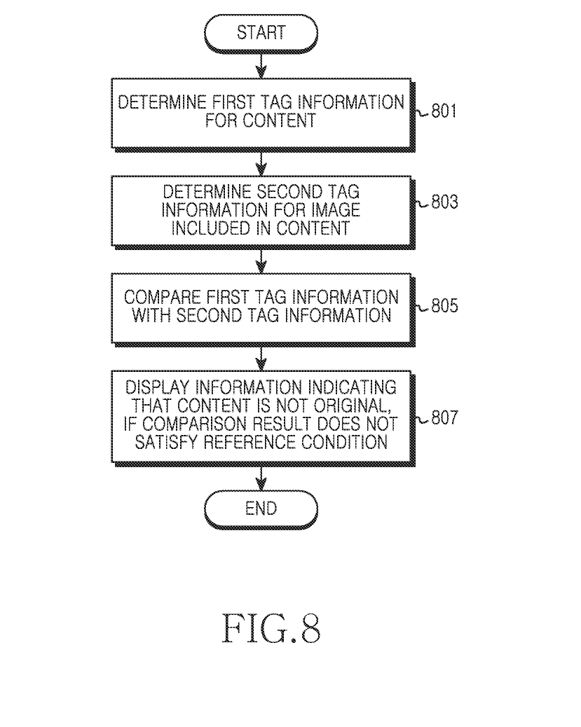

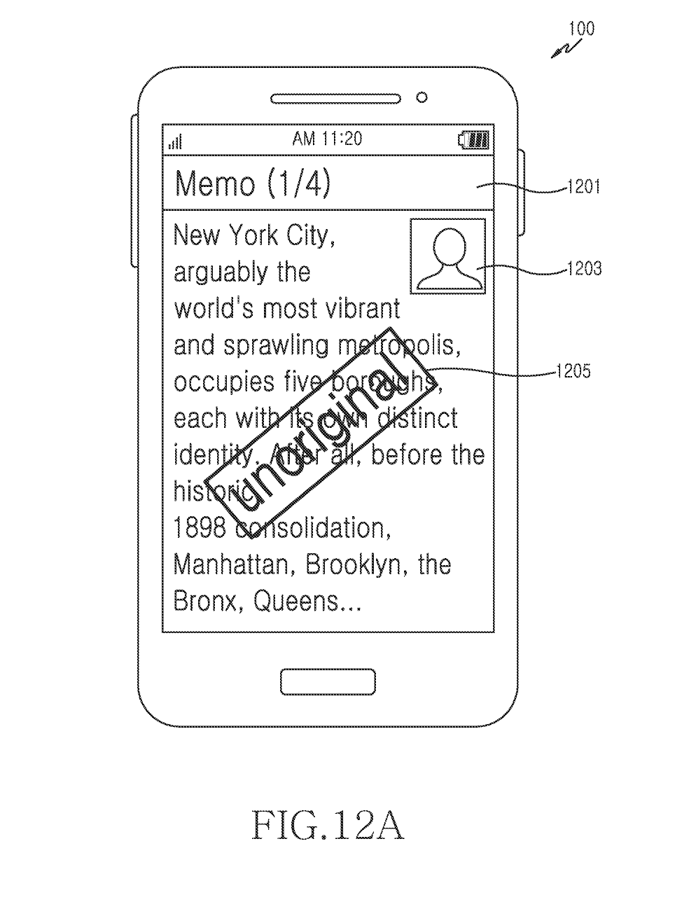

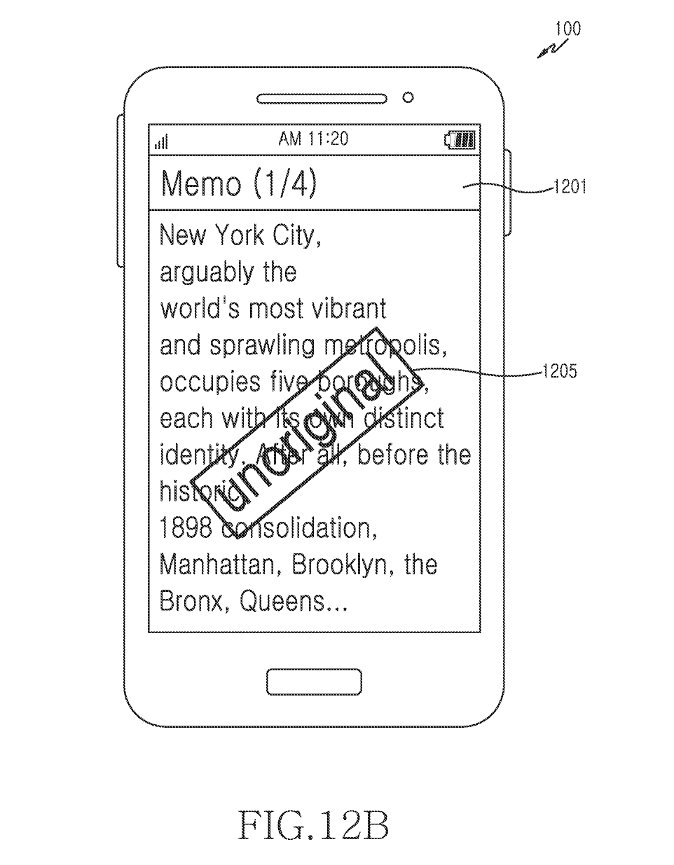

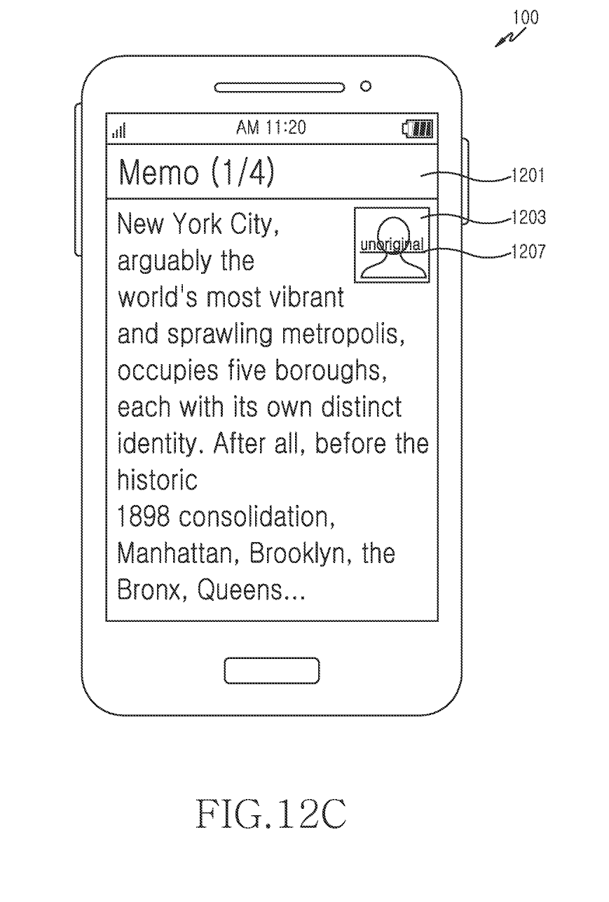

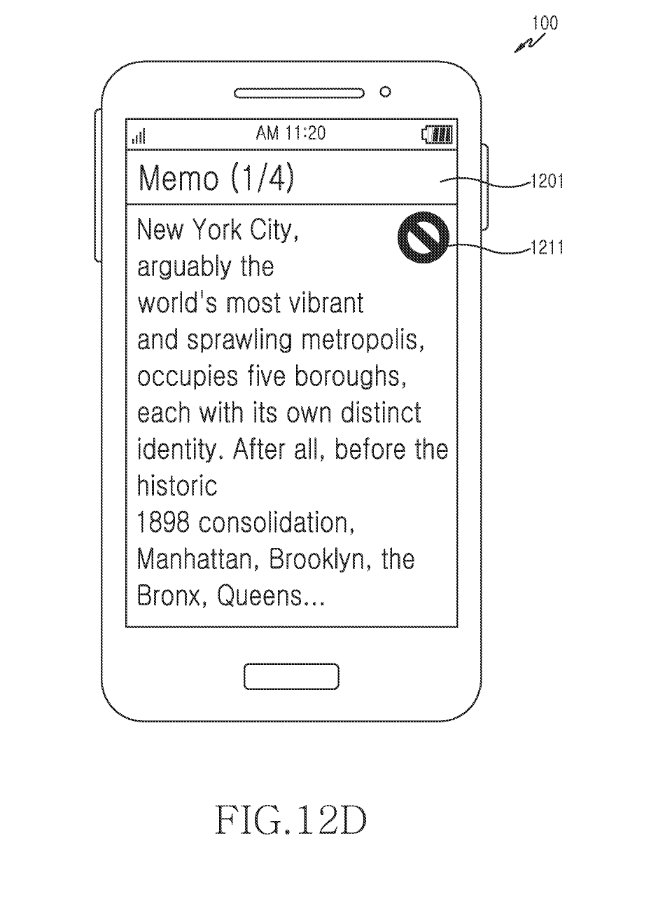

FIG. 8 is a diagram illustrating a procedure of determining whether content is original using tag information of an image included in the content in an electronic device according to various embodiments of the present disclosure. FIGS. 12A, 12B, 12C and 12D are diagrams illustrating screen configurations for indicating whether content is original using tag information included in a content in an electronic device according to various embodiments of the present disclosure.

Referring to FIG. 8, at operation 801, the electronic device determines first tag information for content. For example, when a content display event occurs (e.g., in response to the occurrence of the content display event), the electronic device may determine second tag information determined on the basis of at least one of information on a content creation time, information on the weather at the content creation time, information on a location at the content creation time, and/or the like.

At operation 803, the electronic device determines the second tag information for an image included in the content. For example, the electronic device may determine first tag information on the basis of at least one of information on a time at which the image is inserted into the content, information on the weather at the time at which the image is inserted into the content, information on a location at the time at which the image is inserted into the content, and/or the like.

At operation 805, the electronic device compares the first tag information with the second tag information. For example, the electronic device may determine whether a difference between the content creation time and the time at which the image is inserted into the content is within a reference range. As another example, the electronic device may determine whether a difference between the weather at the content creation time and the weather at the time at which the image is inserted into the content is within a reference range. As another example, the electronic device may determine whether a difference between the location at the content creation time and the location at the time at which the image is inserted into the content is within a reference range.

At operation 807, if a result of the comparison does not satisfy a reference condition, then the electronic device displays information indicating that the content is not original. For example, as illustrated in FIG. 12A, the electronic device may display, on a memo program 1201, a watermark image 1203 and an image 1205 for indicating that the content is not original so that the watermark image 1203 and the image 1205 are superimposed on the content of a memo. As another example, as illustrated in FIG. 12B, the electronic device may display, on the memo program 1201, the image 1205 for indicating that the content is not original so that the image 1205 is superimposed on the content of a memo, without displaying the watermark image. As another example, as illustrated in FIG. 12C, the electronic device may display information 1207 indicating that the content is not original, on the watermark image 1203 included in the memo program 1201. As another example, as illustrated in FIG. 12D, the electronic device may display another image 1211 instead of the original watermark image included in the memo program 1201.

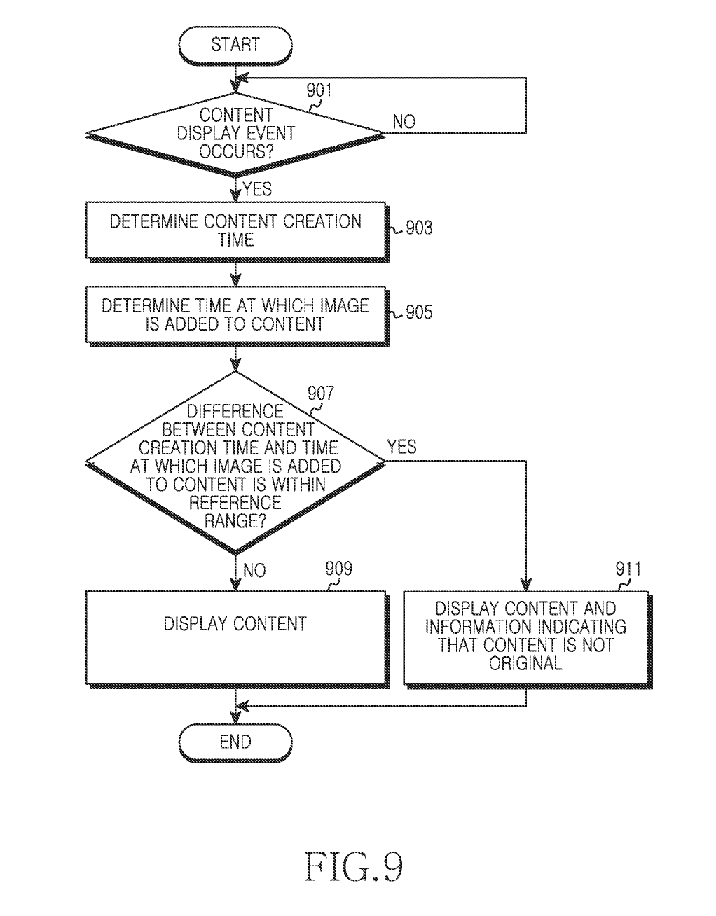

FIG. 9 is a diagram illustrating a procedure of determining whether content is original using time information of an image included in a content in an electronic device according to various embodiments of the present disclosure.

Referring to FIG. 9, at operation 901, the electronic device determines whether a content display event occurs. For example, as illustrated in FIG. 12A, 12B, 12C or 12D, the electronic device may determine whether at least one pre-created memo is displayed through the memo program 1201.

If the electronic device determines that the content display event does not occur at operation 901, then the electronic device may return to operation 901 at which the electronic device continues to poll for occurrence of the content display event.

In contrast, if the electronic device determines that a content display event occurs at operation 901, then the electronic device may proceed to operation 903 at which the electronic device determines a content creation time. For example, in response to occurrence of the content display event, the electronic device may determine a content creation time. For example, when the content display event occurs, the electronic device may determine a memo creation time from a memo. The memo creation time may be a time at which the memo is stored or a time at which the memo is finally edited.

After determining the content creation time at operation 903, the electronic device may proceed to operation 905 at which the electronic device determines a time at which a watermark image is added to the content. For example, the electronic device may determine the time at which the watermark image is inserted into a memo using memo data. As another example, the electronic device may determine the time at which the watermark image is inserted into the memo using EXIF information of the watermark image.

Thereafter, at operation 907, the electronic device determines whether a difference between the content creation time and the time at which the watermark image is added to the content is within a reference range.

If the electronic device determines that a difference between the content creation time and the time at which the watermark image is added to the content is within the reference range at operation 907, then the electronic device may determine that the content is original. Accordingly, the electronic device may proceed to operation 909 at which the electronic device displays the content.

However, if the electronic device determines that the difference between the content creation time and the time at which the watermark image is added to the content is outside the reference range at operation 907, then the electronic device may determine that the content is not original. Accordingly, the electronic device may proceed to operation 911 at which the electronic device additionally displays information indicating that the content is not original when displaying the content. For example, as illustrated in FIG. 12A, the electronic device may display, on the memo program 1201, the watermark image 1203 and the image 1205 for indicating that the content is not original so that the watermark image 1203 and the image 1205 are superimposed on the content of a memo. As another example, as illustrated in FIG. 12B, the electronic device may display, on the memo program 1201, the image 1205 for indicating that the content is not original so that the image 1205 is superimposed on the content of a memo, without displaying the watermark image. As another example, as illustrated in FIG. 12C, the electronic device may display the information 1207 indicating that the content is not original, on the watermark image 1203 included in the memo program 1201. For another example, as illustrated in FIG. 12D, the electronic device may display another image 1211 instead of the original watermark image included in the memo program 1201.

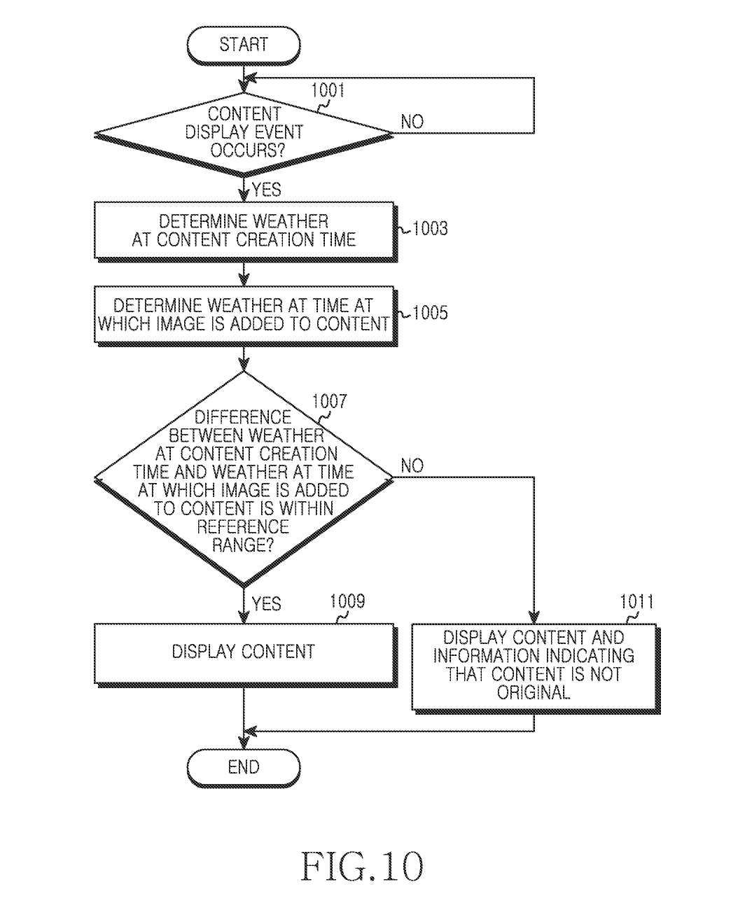

FIG. 10 is a diagram illustrating a procedure of determining whether content is original using weather information of an image included in a content in an electronic device according to various embodiments of the present disclosure.

Referring to FIG. 10, at operation 1001, the electronic device determines whether a content display event occurs. For example, as illustrated in FIG. 12A, 12B, 12C or 12D, the electronic device may determine whether at least one pre-created memo is displayed through the memo program 1201.

If the electronic device determines that the content display event does not occur at operation 1001, then the electronic device may return to operation 1001 at which the electronic device continues to poll for occurrence of the content display event.

In contrast, if the electronic device determines that the content display event occurs at operation 1001, then the electronic device may proceed to operation 1003 at which the electronic device determines the weather at a content creation time. For example, in response to occurrence of the content display event, the electronic device may determine weather information relating to a weather at the content creation time. For example, when a memo display event occurs, the electronic device may determine the weather at a memo creation time from memo data. The weather information may include at least one of a temperature, an amount of rainfall, a rainfall probability, a wind direction, a wind speed, a humidity, and/or the like.

After determining the weather at the content creation time at operation 1003, the electronic device may proceed to operation 1005 at which the electronic device determines the weather at a time at which a watermark image is inserted into the content. For example, the electronic device may determine the weather at the time at which the watermark image is inserted into a memo using the memo data. As another example, the electronic device may determine the weather at the time at which the watermark image is inserted into the memo using the EXIF information of the watermark image.

Thereafter, at operation 1007, the electronic device determines whether a difference between the weather of the content creation time and the weather of the time at which the watermark image is added to the content is within a reference range. For example, the electronic device may determine whether a difference of numerical values of at least one of a temperature, an amount of rainfall, a rainfall probability, a wind direction, a wind speed, a humidity is within the reference range, and/or the like.

If the electronic device determines that the difference between the weather of the content creation time and the weather of the time at which the watermark image is added to the content is within the reference range at operation 1007, then the electronic device may determine that the content is original. Accordingly, the electronic device may proceed to operation 1009 at which the electronic device displays the content.

However, if the electronic device determines that the difference between the weather of the content creation time and the weather of the time at which the watermark image is added to the content is outside the reference range at operation 1007, then the electronic device may determine that the content is not original. Accordingly, the electronic device may proceed to operation 1011 at which the electronic device additionally displays information indicating that the content is not original when displaying the content. For example, as illustrated in FIG. 12A, the electronic device may display, on the memo program 1201, the watermark image 1203 and the image 1205 for indicating that the content is not original so that the watermark image 1203 and the image 1205 are superimposed on the content of a memo. As another example, as illustrated in FIG. 12B, the electronic device may display, on the memo program 1201, the image 1205 for indicating that the content is not original so that the image 1205 is superimposed on the content of a memo, without displaying the watermark image. As another example, as illustrated in FIG. 12C, the electronic device may display the information 1207 indicating that the content is not original, on the watermark image 1203 included in the memo program 1201. As another example, as illustrated in FIG. 12D, the electronic device may display another image 1211 instead of the original watermark image included in the memo program 1201.

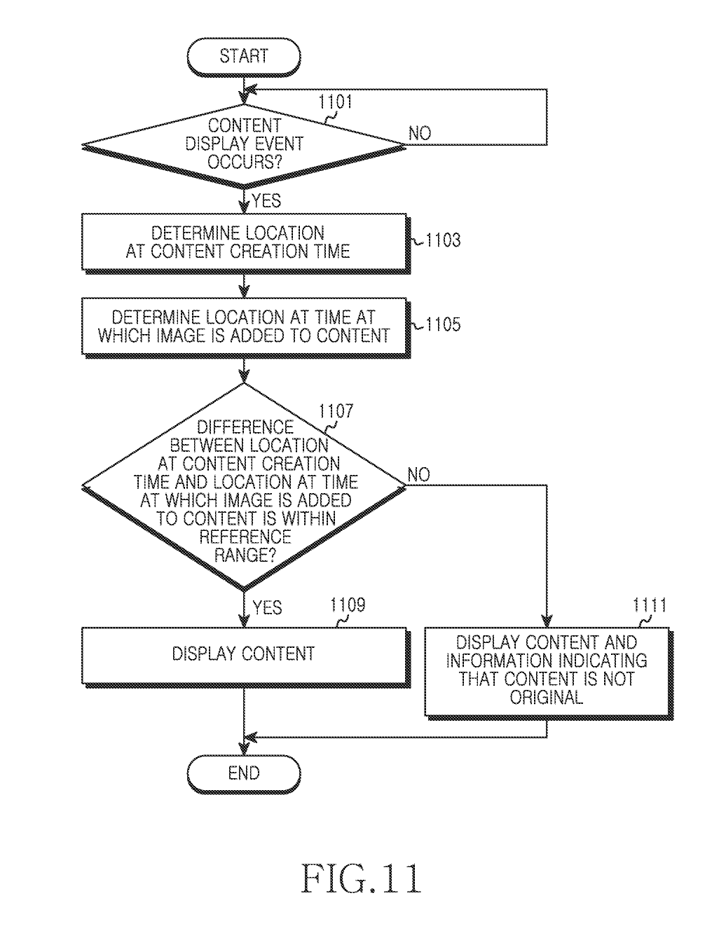

FIG. 11 is a diagram illustrating a procedure of determining whether content is original using location information of an image included in a content in an electronic device according to various embodiments of the present disclosure.

Referring to FIG. 11, at operation 1101, the electronic device determines whether a content display event occurs. For example, as illustrated in FIG. 12A, 12B, 12C or 12D, the electronic device may determine whether at least one pre-created memo is displayed through the memo program 1201.

If the electronic device determines that the content display event does not occur at operation 1101, then the electronic device may return to operation 1101 at which the electronic device continues to poll for occurrence of the content display event.

In contrast, if the electronic device determines that the content display event occurs at operation 1101, then the electronic device may proceed to operation 1103 at which the electronic device determines a location at a content creation time. For example, in response to occurrence of the content display event, the electronic device may determine a location at which an electronic device creates the content at the content creation time. For example, when a memo display event occurs, the electronic device may determine a location at a memo creation time from memo data.

After determining the location at the content creation time at operation 1103, the electronic device may proceed to operation 1105 at which the electronic device determines the location at a time at which a watermark image is inserted into the content. For example, the electronic device may determine the location at the time at which the watermark image is inserted into a memo using the memo data. As another example, the electronic device may determine the location at the time at which the watermark image is inserted into the memo using the EXIF information of the watermark image.

Thereafter, at operation 1107, the electronic device determines whether a difference between the location at the content creation time and the location at the time at which the watermark image is added to the content is within a reference range.

If the electronic device determines that the difference between the location at the content creation time and the location at the time at which the watermark image is added to the content is within the reference range at operation 1107, then the electronic device may determine that the content is original. Accordingly, the electronic device may proceed to operation 1109 at which the electronic device displays the content.

However, if the electronic device determines that the difference between the location at the content creation time and the location at the time at which the watermark image is added to the content is outside the reference range at operation 1107, then the electronic device may determine that the content is not original. Accordingly, the electronic device may proceed to operation 1111 at which the electronic device additionally displays information indicating that the content is not original when displaying the content. For example, as illustrated in FIG. 12A, the electronic device may display, on the memo program 1201, the watermark image 1203 and the image 1205 for indicating that the content is not original so that the watermark image 1203 and the image 1205 are superimposed on the content of a memo. As another example, as illustrated in FIG. 12B, the electronic device may display, on the memo program 1201, the image 1205 for indicating that the content is not original so that the image 1205 is superimposed on the content of a memo, without displaying the watermark image. As another example, as illustrated in FIG. 12C, the electronic device may display the information 1207 indicating that the content is not original, on the watermark image 1203 included in the memo program 1201. As another example, as illustrated in FIG. 12D, the electronic device may display another image 1211 instead of the original watermark image included in the memo program 1201.

As described above, the electronic device displays information indicating that content is not original when forgery of the content is detected (e.g., in response to detecting that the content is not genuine) as a result of comparing the tag information of the content and the tag information of an image inserted into the content, thereby enabling a user to determine whether the content is forged.

The methods according to the embodiments disclosed in the claims and/or the description of the present disclosure may be implemented in the form of hardware, software or a combination thereof.

In the case of implementation by software, a non-transitory computer-readable recording medium for storing at least one program (software module) may be provided. The at least one program stored in the non-transitory computer-readable storage medium is configured to be performed by at least one processor in an electronic device. The at least one program includes commands for instructing the electronic device to perform the methods according to the embodiments disclosed in the claims and/or the description of the present disclosure.

The program (software module or software) may be stored in a random access memory, a non-volatile memory including a flash memory, a read-only memory (ROM), an electrically erasable programmable ROM (EEPROM), a magnetic disk storage device, a compact disk ROM (CD-ROM), a DVD, another type of an optical storage device, and a magnetic cassette. Alternatively, the program may be stored in a memory configured with a combination of some or all of the above-mentioned storage devices. Furthermore, each memory may be provided in a plurality.

Furthermore, the program may be stored in an attachable storage device that may access the electronic device via a communication network such as the Internet, an intranet, a LAN, a WLAN or a SAN or a communication network configured with a combination thereof. Such storage device may be connected to the electronic device through an external port.

Furthermore, an additional storage device on a communication network may be connected to the electronic device.

Although the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
detecting a first tag information based on a content accessible by the electronic device;
detecting a second tag information based on an image included in the content;
comparing the first tag information with the second tag information; and
displaying information indicating that the content is not original on the content, when the first tag information and the second tag information do not satisfy a reference condition.

2. The method of claim 1, wherein the first tag information comprises at least one of information on a creation time of the content, information on weather at the creation time of the content, and information on a location at the creation time of the content.

3. The method of claim 1, wherein the second tag information comprises at least one of information on a time at which the image is inserted into the content, information on weather at the time at which the image is inserted into the content, and information on a location at the time at which the image is inserted into the content.

4. The method of claim 1, wherein the displaying of the information indicating that the content is not original comprises displaying the information indicating that the content is not original on the image.

5. The method of claim 1, wherein the displaying of the information indicating that the content is not original comprises displaying the information indicating that the content is not original without displaying the image.

6. The method of claim 1, wherein the displaying of the information indicating that the content is not original comprises notifying that the content is not original by generating an acoustic signal or a tactile signal.

7. The method of claim 1, wherein the second tag information comprises contextual information relating to one or more of an insertion of the image in the content, a creation of the image, and the electronic device, and
wherein second tag information is determined so as to be contemporaneous with the insertion of the image in the content.

8. A method for controlling content in an electronic device, the method comprising:
adding second tag information to an image to insert the image into content; and
adding first tag information to the content to store the content.

9. The method of claim 8, wherein the adding the second tag information to the image to insert the image into the content comprises displaying the image on the content.

10. The method of claim 8, wherein the adding the first tag information to the content to store the content comprises synthesizing the image and the content to store the image and the content as a single file.

11. The method of claim 8, wherein the adding the first tag information to the content to store the content comprises storing the image and the content as different files.

12. An electronic device comprising:
a memory;
a display; and
a processor configured to detect first tag information based on content stored in the memory, detect second tag information based on an image included in the content, compare the first tag information with the second tag information, and control the display so that information indicating that the content is not original is displayed on the content when the first tag information, and the second tag information do not satisfy a reference condition.

13. The device of claim 12, wherein the first tag information comprises at least one of information on a creation time of the content, information on weather at the creation time of the content, and information on a location at the creation time of the content.

14. The device of claim 12, wherein the second tag information comprises at least one of information on a time at which the image is inserted into the content, information on weather at the time at which the image is inserted into the content and information on a location at the time at which the image is inserted into the content.

15. The device of claim 12, wherein the processor is further configured to control the display so that the information indicating that the content is not original is displayed on the image if the content is not original.

16. The device of claim 12, wherein the processor is further configured to control the display so that the image is not displayed if the content is not original.

17. The device of claim 12, wherein the processor is further configured to generate an acoustic signal or a tactile signal if the content is not original.

18. The device of claim 12, wherein the second tag information comprises contextual information relating to one or more of an insertion of the image in the content, a creation of the image, and the electronic device, and
wherein the second tag information is determined so as to be contemporaneous with the insertion of the image in the content.

19. An electronic device comprising:
a memory;
a display; and
at least one processor configured to add second tag information to an image, insert the image into content, add first tag information to the content, and store the content in the memory.

20. The device of claim 19, wherein the processor is further configured to control the display so that the image is displayed on the content when the second tag information is added to the image and the image is inserted into the content.

21. The device of claim 19, wherein the processor is further configured to synthesize the image and the content so that the image and the content are stored as a single file in the memory.

22. The device of claim 19, wherein the processor is further configured to store the image and the content as different files in the memory.

23. A method in an electronic device, the method comprising:
generating metadata associated with content;
generating a watermark to be included with the content;
detecting contextual information contemporaneous with the generation of the watermark;
generating metadata associated with the watermark according to the detected contextual information; and
inserting the watermark and associated metadata in the content.

24. The method of claim 23, further comprising:
opening the content; and
in response to the opening of the content, determining whether the metadata associated with the content and the metadata associated with the watermark match within a predetermined threshold.

25. The method of claim 24, further comprising:
in response to the determining that the metadata associated with the content and the metadata associated with the watermark match, providing an indication that the opened content is genuine.

26. The method of claim 24, further comprising:
in response to the determining that the metadata associated with the content and the metadata associated with the watermark do not match, providing an indication that the opened content is not genuine.
